(19) United States
(12) Patent Application Publication
(10) Pub. No.: US 2019/0369056 A1
(43) Pub. Date: Dec. 5, 2019

(54) DEFECT IMAGING METHOD FOR LINING ANTI-CORROSION PIPELINE

(71) Applicant: GUANGZHOU SPECIAL PRESSURE EQUIPMENT INSPECTION AND RESEARCH INSTITUTE, Guangzhou City (CN)

(72) Inventors: Maodong LI, Guangzhou City (CN); Bo YANG, Guangzhou City (CN); Wei ZHAI, Guangzhou City (CN); Guojia HUANG, Guangzhou City (CN); Shiping LI, Guangzhou City (CN); Zhigang WANG, Guangzhou City (CN); Ronggen LI, Guangzhou City (CN); Zhiqiang ZHONG, Guangzhou City (CN)

(21) Appl. No.: 16/424,527

(22) Filed: May 29, 2019

(30) Foreign Application Priority Data
May 30, 2018 (CN) 201810537009.4

(51) Int. Cl. G01N 29/06; G01N 29/24; G01N 29/28; F17D 5/06

(52) U.S. Cl. CPC G01N 29/069; G01N 29/2437; G01N 2291/269; F17D 5/06; G01N 2291/023; G01N 29/28

(57) ABSTRACT

A defect imaging method for a lining anti-corrosion pipeline is provided, including following steps: loading an imaging excitation signal to the lining anti-corrosion pipeline under detection; acquiring an imaging excitation reflection signal and an imaging excitation transmission signal; obtaining bending mode guided waves of the imaging excitation reflection signal and the imaging excitation transmission signal respectively, and performing time reversal processing on the bending mode guided waves to obtain time-reversed signals; performing excitation reversal on the time-reversed signals to obtain excitation reversal data; performing temporal and spatial focusing processing on the excitation reversal data to obtain a vibration cloud diagram; and converting the vibration cloud diagram into a three-dimensional color point cloud diagram to image a defect of the lining anti-corrosion pipeline. By performing imaging processing, the defect position and condition can be obtained visually and clearly, thereby greatly facilitating subsequent maintenance work.

### CROSS-REFERENCE TO RELATED APPLICATIONS

This application claims priority to Chinese Application No. CN 201810537009.4 having a filing date of May 30, 2018, the entire contents of which are hereby incorporated by reference.

### FIELD OF TECHNOLOGY

The following relates to the field of pipeline defect detection, and in particular relates to a defect imaging method for a lining anti-corrosion pipeline.

### BACKGROUND

The petrochemical industry is an important foundation and pillar industry of the national economy and plays a decisive role in the sustained and stable development of the national economy. In the petrochemical industry, anti-corrosion pressure pipelines are commonly used for oil and gas conveyance.

The traditional anti-corrosion pressure pipeline mainly includes an outer anti-corrosion layer pressure pipeline and a lining anti-corrosion pressure pipeline. The outer anti-corrosion layer pressure pipeline is a pressure pipeline formed by providing an anti-corrosion layer on the outer side of the pressure pipeline, and the lining anti-corrosion pressure pipeline is a pressure pipeline formed by providing an anti-corrosion layer on the inner side of the pipeline. As the anti-corrosion layer of the lining anti-corrosion pressure pipeline is directly in the environment of fluid, corrosion, mixture of various chemicals or the like, it is very likely to be corroded to cause defects, resulting in leakage. For this reason, the detection of defects in the lining anti-corrosion pressure pipeline is particularly important.

When the lining anti-corrosion pressure pipeline has defects, some physical properties and chemical properties of the anti-corrosion material layer of the lining anti-corrosion pressure pipeline can change, thereby causing some microscopic or macroscopic changes in the lining anti-corrosion material layer. By detecting the defects of the lining anti-corrosion material layer, information related to the performance of the lining anti-corrosion pressure pipeline can be obtained, and the performance of the lining anti-corrosion pressure pipeline can be quickly and effectively evaluated to determine a reasonable maintenance time. In this way, accidents and economic losses caused by anti-corrosion layer failure can be effectively avoided. Therefore, how to find and determine the defects of the lining anti-corrosion pressure pipeline has become a research subject.

### SUMMARY

An aspect relates to providing a defect imaging method for a lining anti-corrosion pipeline, which has the advantage that the defect position and condition of the lining anti-corrosion pipeline under detection can be obtained visually and clearly, thereby greatly facilitating subsequent maintenance work on the lining anti-corrosion pipeline under detection.

The defect imaging method for a lining anti-corrosion pipeline includes the following steps:
loading an imaging excitation signal to the lining anti-corrosion pipeline under detection;
acquiring an imaging excitation reflection signal and an imaging excitation transmission signal fed back after the imaging excitation signal passes through the lining anti-corrosion pipeline under detection;
obtaining a bending mode guided wave of the imaging excitation reflection signal and a bending mode guided wave of the imaging excitation transmission signal respectively, and performing time reversal processing on the bending mode guided waves of the two types of signals respectively to obtain time-reversed signals of the two types of signals;
performing excitation reversal on the time-reversed signals of the two types of signals respectively to obtain two sets of excitation reversal data;
performing temporal and spatial focusing processing on the two sets of excitation reversal data to obtain a vibration cloud diagram; and
converting the vibration cloud diagram into a three-dimensional color point cloud diagram to image a defect of the lining anti-corrosion pipeline.

Compared with the known art, by performing imaging processing of the three-dimensional color point cloud diagram on the lining anti-corrosion pipeline under detection in embodiments of the present invention, the defect position and condition can be obtained visually and clearly, thereby greatly facilitating subsequent maintenance work on the lining anti-corrosion pipeline under detection. The time reversal processing on the bending mode guided waves can ensure the defect of the lining anti-corrosion pipeline under detection is shown completely.

Further, loading the imaging excitation signal to the lining anti-corrosion pipeline under detection includes: arranging a first excitation transducer array and a second excitation transducer array at two ends in the axial direction of the lining anti-corrosion pipeline under detection respectively; and loading the imaging excitation signal to the first excitation transducer array or the second excitation transducer array to transmit the imaging excitation signal to the lining anti-corrosion pipeline under detection.

Both the first excitation transducer array and the second excitation transducer array adopt piezoelectric ceramics based on piezoelectric effect, and both are adhered to the surface of the lining anti-corrosion pipeline under detection through a couplant.

Further, the imaging excitation signal is an ultrasonic signal. The ultrasonic guided wave detection can effectively enhance the signal amplitude and improve the signal-to-noise ratio, and effectively achieves the long-distance accurate detection of the long structure of the lining anti-corrosion pipeline.

Further, in acquiring the imaging excitation reflection signal and the imaging excitation transmission signal, a synchronous interface sync of a waveform generator for generating the imaging excitation signal is connected to an external trigger interface of a data acquisition card, and the imaging excitation reflection signal and the imaging excitation transmission signal are led to different paths of the data acquisition card respectively, to achieve synchronous acquisition of the imaging excitation reflection signal and the imaging excitation transmission signal, thereby improving the accuracy of subsequent data processing.

Further, the time reversal processing on the bending mode guided waves of the two types of signals respectively is carried out in such a manner that the bending mode guided waves of the two types of signals are imported into digital processing software respectively, and are reversed from an order of the bending mode guided waves arriving at the arrays to obtain the time-reversed signals of the two types of signals.

Further, obtaining the excitation reversal data is achieved in such a manner that according to parameter information of the lining anti-corrosion pipeline under detection provided by a manufacturer, a model corresponding to the lining anti-corrosion pipeline under detection is established and simulation parameters are set in finite element model software, and the two sets of excitation reversal data are obtained after simulation.

Further, obtaining the vibration cloud diagram is achieved in such a manner that a displacement value of each point of the lining anti-corrosion pipeline under detection in the two sets of excitation reversal data is multiplied, and then products at all moments are superimposed to obtain a stress value of each point of the lining anti-corrosion pipeline under detection at every moment, and then the vibration cloud diagram is obtained according to the stress value.

Further, converting the vibration cloud diagram into the three-dimensional color point cloud diagram is achieved in such a manner that the stress values of the vibration cloud diagram and a defined RGB spatial curve are mapped to obtain the three-dimensional color point cloud diagram.

For the sake of better understanding and implementation, embodiments of the present invention are described in detail below in conjunction with the accompanying drawings.

### BRIEF DESCRIPTION

Some of the embodiments will be described in detail, with reference to the following figures, wherein like designations denote like members, wherein:

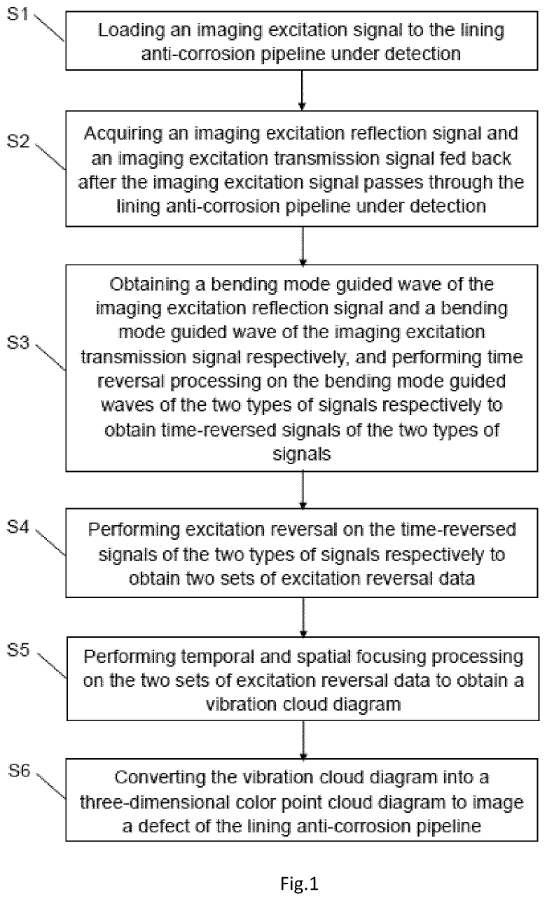

FIG. 1 is a flow diagram of a defect imaging method for a lining anti-corrosion pipeline in embodiments of the present invention;

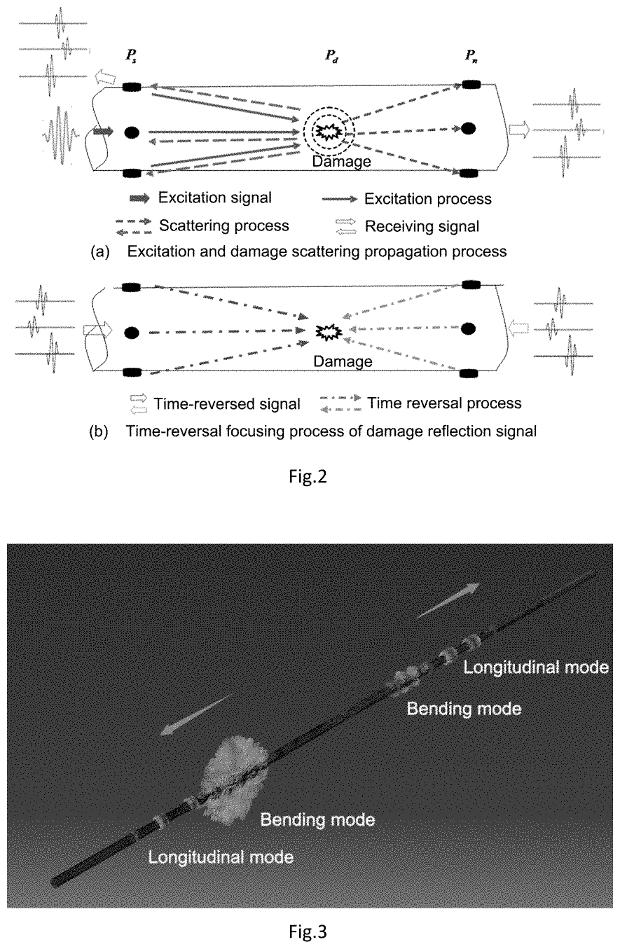

FIG. 2 is a schematic diagram of scattering and time-reversal focusing of an imaging excitation signal;

FIG. 3 is a simulation graph after time-reversed signals of two types of signals are subjected to excitation reversal respectively;

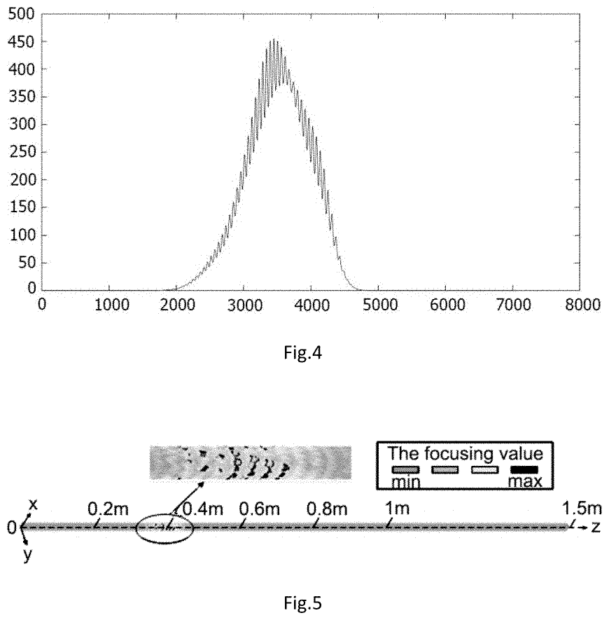

FIG. 4 is a vibration cloud diagram in embodiments of the present invention; and

FIG. 5 is a three-dimensional color point cloud diagram in embodiments of the present invention.

### DETAILED DESCRIPTION

Refer to FIG. 1, which is a flow diagram of a defect imaging method for a lining anti-corrosion pipeline in embodiments of the present invention. The defect imaging method for a lining anti-corrosion pipeline includes the following steps:

Step S1: loading an imaging excitation signal to a lining anti-corrosion pipeline under detection.

In an embodiment, to image a defect of the lining anti-corrosion pipeline under detection, a first excitation transducer array and a second excitation transducer array are arranged at two ends in the axial direction of the lining anti-corrosion pipeline under detection respectively. Specifically, both the first excitation transducer array and the second excitation transducer array adopt piezoelectric ceramics based on the piezoelectric effect, and both are adhered to the surface of the lining anti-corrosion pipeline under detection through a couplant, to achieve vibration and electric signal conversion of the lining anti-corrosion pipeline under detection. The imaging excitation signal is loaded to the first excitation transducer array or the second excitation transducer array to transmit the imaging excitation signal to the lining anti-corrosion pipeline under detection.

In an embodiment, the imaging excitation signal is an ultrasonic signal.

Refer to FIG. 2, which is a schematic diagram of scattering and time-reversal focusing of the imaging excitation signal; wherein FIG. 2(a) is a scattering diagram of the imaging excitation signal; and FIG. 2(b) is a time-reversal focusing diagram.

Step S2: acquiring an imaging excitation reflection signal and an imaging excitation transmission signal fed back after the imaging excitation signal passes through the lining anti-corrosion pipeline under detection.

The imaging excitation signal is scattered after being loaded to the lining anti-corrosion pipeline under detection, wherein a part of the signal is transmitted and fed back to the first excitation transducer array PS or the second excitation transducer array Pn loaded with the imaging excitation signal, to obtain the imaging excitation reflection signal; and the other part passes through the lining anti-corrosion pipeline under detection and is fed back to the second excitation transducer array Pn or the first excitation transducer array PS not loaded with the imaging excitation signal, to obtain the imaging excitation transmission signal.

To achieve the accuracy of data acquisition, in an embodiment, the imaging excitation transmission signal and the imaging excitation reflection signal are acquired synchronously through a data acquisition card. Specifically, a synchronous interface sync of a waveform generator that generates the imaging excitation signal is connected to an external trigger interface of the data acquisition card, such that the data acquisition card starts acquisition when the imaging excitation signal is loaded, and the consistency of the starting time of each sampling is ensured. Furthermore, the first excitation transducer array Ps or the second excitation transducer array Pn for acquiring the imaging excitation reflection signal and the second excitation transducer array Pn or the first excitation transducer array Ps for acquiring the imaging excitation transmission signal are connected to different paths of the data acquisition card respectively, to ensure the signals at the two ends are acquired synchronously every time the imaging excitation signal is loaded.

Refer to FIG. 3, which is a simulation graph after time-reversed signals of the two types of signals are subjected to excitation reversal respectively.

Step S3: obtaining a bending mode guided wave of the imaging excitation reflection signal and a bending mode guided wave of the imaging excitation transmission signal respectively, and performing time reversal processing on the bending mode guided waves of the two types of signals respectively to obtain time-reversed signals of the two types of signals.

The imaging excitation signal loaded to the lining anti-corrosion pipeline under detection can generate the bending mode guided waves when encountered with a defect caused by a non-axisymmetric damage, and the wave velocities of the guided waves of different modes can be derived from a dispersion curve and an excitation signal frequency of the lining anti-corrosion pipeline under detection, so that the needed bending mode guided waves can be extracted. Specifically, the principle of obtaining the bending mode guided waves of the imaging excitation reflection signal and the imaging excitation transmission signal is as follows: supposing a longitudinal mode L and a bending mode F are excited by the imaging excitation signal F(ω), and transfer functions generated at a distance are H_{L}(ω) and H_{F} (ω), a received hybrid mode guided wave signal is G_{LF}(ω)=F(ω)H_{L}(ω)+F(ω)H_{F}(ω); G_{LF}(ω) is compensated by using H_{L}⁻¹ (ω) first to obtain G_{LF}(ω)H_{L}⁻¹(ω)=F(ω)+F(ω)H_{F}(ω)H_{L}⁻¹(ω), which formula is subjected to inverse Forier's transform to obtain a time-domain signal; F(ω) is eliminated from the compensated signal to arrive at a result, which is then changed to a frequency domain and compensated inversely by using H_{L}(ω) to obtain a frequency spectrum (G_{LF}(ω)H_{L}⁻¹ (ω)−F(ω))H_{L}(ω)=F(ω)H_{F}(ω) of the bending mode F; and the frequency spectrum is subjected to inverse Forier's transform to obtain a corresponding time-domain waveform.

Time reversal refers to a reversed-order processing method in which acquired signals are reversed in the time domain. In an embodiment, the extracted bending mode guided waves are imported into digital processing software, and are reversed from the order of the bending mode guided waves arriving at the arrays to generate the time-reversed signals.

Step S4: performing excitation reversal on the time-reversed signals of the two types of signals respectively to obtain two sets of excitation reversal data.

In an embodiment, the time-reversed signals of the two types of signals are imported into a finite element simulation model for excitation reversal respectively to obtain the two sets of excitation reversal data of the lining anti-corrosion pipeline under detection. Specifically, according to parameter information of the lining anti-corrosion pipeline under detection provided by a manufacturer, a model corresponding to the lining anti-corrosion pipeline under detection is established and simulation parameters are set in finite element model software, and the two sets of excitation reversal data are obtained after simulation. The excitation reversal data include the displacement of each point in the lining anti-corrosion pipeline under detection.

Please refer to FIG. 4, which is a vibration cloud diagram in embodiments of the present invention.

Step S5: performing temporal and spatial focusing processing on the two sets of excitation reversal data to obtain the vibration cloud diagram.

The displacement value generated when the lining anti-corrosion pipeline under detection is excited, that is, the displacement value of each point of the lining anti-corrosion pipeline under detection in the two sets of excitation reversal data is multiplied, and then products at all moments are superimposed to obtain a stress value of each point of the lining anti-corrosion pipeline under detection at every moment, and then the vibration cloud diagram is obtained according to the stress value. In an embodiment, the displacement value of each point in the two sets of excitation reversal data is exported, and imported to data processing software for temporal and spatial focusing processing to obtain the vibration cloud diagram.

Refer to FIG. 5, which is a three-dimensional color point cloud diagram in embodiments of the present invention, showing an image subjected to gray processing, wherein the part in an oval frame represents a defect position and a defect image.

Step S6: converting the vibration cloud diagram into the three-dimensional color point cloud diagram to image the defect of the lining anti-corrosion pipeline.

By mapping the stress values of the vibration cloud diagram and a defined RGB spatial curve, the stress values can be distributed in obvious color gradation, so that the position and condition of the defect caused by damage of the interface of the lining anti-corrosion pipeline under detection can be obviously distinguished to perform subsequent defect analysis processing.

Compared with the known art, by performing imaging processing of the three-dimensional color point cloud diagram on the lining anti-corrosion pipeline under detection in embodiments of the present invention, the defect position and condition can be obtained visually and clearly, thereby greatly facilitating subsequent maintenance work on the lining anti-corrosion pipeline under detection. The time reversal processing on the bending mode guided waves can ensure the defect of the lining anti-corrosion pipeline under detection is shown completely. Further, the ultrasonic guided wave detection can effectively enhance the signal amplitude and improve the signal-to-noise ratio, and effectively achieves the long-distance accurate detection of the long structure of the lining anti-corrosion pipeline interface.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

What is claimed:

1. A defect imaging method for a lining anti-corrosion pipeline, comprising following steps:
loading an imaging excitation signal to the lining anti-corrosion pipeline under detection;
acquiring an imaging excitation reflection signal and an imaging excitation transmission signal fed back after the imaging excitation signal passes through the lining anti-corrosion pipeline under detection;
obtaining a bending mode guided wave of the imaging excitation reflection signal and a bending mode guided wave of the imaging excitation transmission signal respectively, and performing time reversal processing on the bending mode guided waves of the two types of signals respectively to obtain time-reversed signals of the two types of signals;
performing excitation reversal on the time-reversed signals of the two types of signals respectively to obtain two sets of excitation reversal data;
performing temporal and spatial focusing processing on the two sets of excitation reversal data to obtain a vibration cloud diagram; and
converting the vibration cloud diagram into a three-dimensional color point cloud diagram to image a defect of the lining anti-corrosion pipeline.

2. The defect imaging method of claim 1, wherein loading the imaging excitation signal to the lining anti-corrosion pipeline under detection comprising:
arranging a first excitation transducer array and a second excitation transducer array at two ends in the axial direction of the lining anti-corrosion pipeline under detection respectively; and
loading the imaging excitation signal to the first excitation transducer array or the second excitation transducer array to transmit the imaging excitation signal to the lining anti-corrosion pipeline under detection.

3. The defect imaging method of claim 2, wherein both the first excitation transducer array and the second excitation transducer array adopt piezoelectric ceramics based on piezoelectric effect, and both are adhered to the surface of the lining anti-corrosion pipeline under detection through a couplant.

4. The defect imaging method of claim 1, wherein the imaging excitation signal is an ultrasonic signal.

5. The defect imaging method of claim 1, wherein in acquiring the imaging excitation reflection signal and the imaging excitation transmission signal, a synchronous interface sync of a waveform generator for generating the imaging excitation signal is connected to an external trigger interface of a data acquisition card, and the imaging excitation reflection signal and the imaging excitation transmission signal are led to different paths of the data acquisition card respectively, to achieve synchronous acquisition of the imaging excitation reflection signal and the imaging excitation transmission signal.

6. The defect imaging method of claim 1, wherein the time reversal processing on the bending mode guided waves of the two types of signals respectively is carried out in such a manner that the bending mode guided waves of the two types of signals are imported into digital processing software respectively, and are reversed from an order of the bending mode guided waves arriving at the arrays to obtain the time-reversed signals of the two types of signals.

7. The defect imaging method of claim 1, wherein obtaining the excitation reversal data is achieved in such a manner that according to parameter information of the lining anti-corrosion pipeline under detection provided by a manufacturer, a model corresponding to the lining anti-corrosion pipeline under detection is established and simulation parameters are set in finite element model software, and the two sets of excitation reversal data are obtained after simulation.

8. The defect imaging method of claim 1, wherein obtaining the vibration cloud diagram is achieved in such a manner that a displacement value of each point of the lining anti-corrosion pipeline under detection in the two sets of excitation reversal data is multiplied, and then products at all moments are superimposed to obtain a stress value of each point of the lining anti-corrosion pipeline under detection at every moment, and then the vibration cloud diagram is obtained according to the stress value.

9. The defect imaging method of claim 2, wherein converting the vibration cloud diagram into the three-dimensional color point cloud diagram is achieved in such a manner that the stress values of the vibration cloud diagram and a defined RGB spatial curve are mapped to obtain the three-dimensional color point cloud diagram.
